(19) United States
(12) Patent Application Publication
(10) Pub. No.: US 2011/0153439 A1
(43) Pub. Date: Jun. 23, 2011

(54) COMPUTERIZED DEVICE FOR SALE OF GOODS AND SERVICES

(76) Inventors: Emil Dimitrov, Plovdiv (BG); Nikolay Ganev, Plovdiv (BG)

(21) Appl. No.: 12/863,442

(22) PCT Filed: Feb. 5, 2009
(86) PCT No.: PCT/BG09/00001

§ 371 Date: Jul. 18, 2010

(30) Foreign Application Priority Data
Feb. 19, 2008 (BG) 1411

(51) Int. Cl. G06Q 20/00

(52) U.S. Cl. 705/17

(57) ABSTRACT

The computerized device for sale of goods and/or services comprises the banknote validating device (1) connected to the computer (2) through connection (11) and the POS terminal (13) coupled to the computer (2) through connection (14). The computer (2) contains a processor with x86 processor architecture or processor with RISC processor architecture and is equipped with appropriate software to control the signals, and is connected to the memory (4). The computer (2) is further coupled to a console part which, depending on the specific embodiment, may consists of a display (6), a keyboard (5) and/or a printer (7); the computer is further connected to executive devices (9) that may be more than one and to a change return device—banknote dispenser (12). The device may be used in all fields of human life where it is preferable to avoid human interference in the sale of goods and/or services.

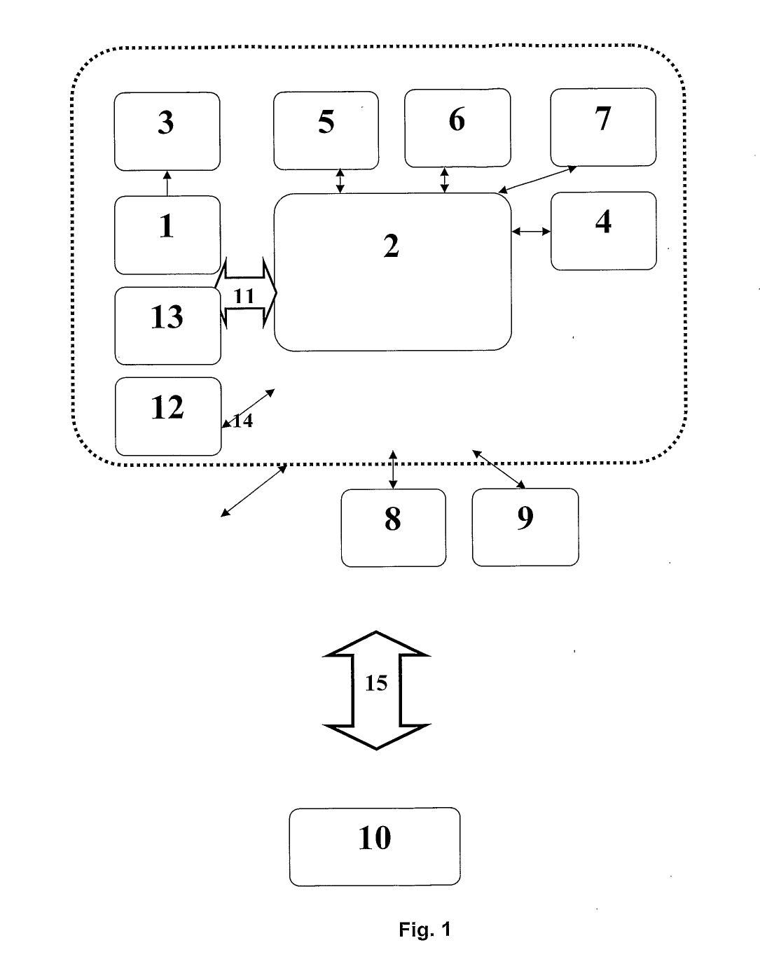

### TECHNICAL FIELD

The computerized device for sale of goods and/or services may be used in all cases when it is necessary to verify the denomination and the authenticity of banknotes and availability on bank cards used to pay for the service or goods without the presence of a human while such presence was until now required in view of verifying the denomination and authenticity of banknotes or the availability on bank cards followed by judgment whether to provided the requested goods or services. Therefore, the computerized device for sale of goods and/or services may find applications in all fields of human life.

### PRIOR ART

Known is the banknote validating devices (BVD) disclosed in patent U.S. Pat. No. 7,212,948 B2 and U.S. Pat. No. 6,392,863 C1 (6047th) BANKNOTE VALIDATOR, U.S. Pat. No. 2004134981 and U.S. Pat. No. 4,386,432, which consists of a banknote dispensing transport device, a set of optical, magnetic and electrical resistance sensors that recognize the denomination and the authenticity of the banknote and further device that transports the banknote to a box for storage of validated banknotes. This device is used in many electrical and mechanical devices in all kinds of services.

Known are many electronic digital devices containing processor with x86 processor architecture or processor with RISC processor architecture, memory and console devices (devices for communication with human—printers, displays, keyboards, tablets, etc.) known under the generic term of computers or computerized devices.

### TECHNICAL INNOVATION OF THE UTILITY MODEL

The goal of the utility model is to create a computerized device for sale of goods and/or services, that helps eliminate the weaknesses of the existing analogue equipment by replacement of the analogue control unit by a computerized digital system.

The goal is achieved by the creation of a computerized system that includes a banknote recognition device and a POS terminal connected to a computer through standard interface and appropriate software, which controls the activity of the whole system. The computer includes memory and is connected to a console part and executive devices that, depending on the specific version, may be more than one.

The proposed solution includes the banknote validating device with banknote storage box connected to a computer through USB, serial port or any other known way, and POS terminal coupled to the computer through a separate connection. The computer is a system built on processor with x86 processor architecture or processor with RISC processor architecture, with installed appropriate software to control the data transfer between the computer and the other connected devices. The computer is coupled to a console part which, depending on the specific version, may comprise a display, a keyboard and a printer; it is also connected to executive devices and to a change return device or banknote dispenser. The console part, the executive devices and the dispenser are peripheral devices connected to the computer. All these devices are mounted together in a common housing.

The system consisting of BVD, POS terminal and computer allows for two way connection through a connection device to remote computer systems (servers) in view of providing services that require immediate download of information from these remote computer systems (servers). The system further allows for remote update of the prices of the provided goods and/or services as well as obtaining information of the availability of banknotes and materials for the provided services.

The proposed solution allows for elimination of the weaknesses of the analogue equipment by replacing the analogue control unit by a computerized system.

### DESCRIPTION OF THE DRAWINGS

Drawing 1: Block diagram of the computerized device for sale of goods and/or services comprising

### POSSIBLE CONSTRUCTION OF THE INVENTION OF THE UTILITY MODEL

The computerized device for sale of goods and/or services comprises a banknote validating device 1 connected to the computer 2 through connection 11, and a POS terminal 13 coupled to the computer 2 through connection 14. The computer 2 is computer containing processor with x86 processor architecture or processor with RISC processor architecture, with installed appropriate software for control of the information and it is connected to memory 4. The computer 2 is further coupled to a console part which, depending on the specific version, may consist of a display 6, a keyboard 5 and/or printer 7; it is further connected to executive devices 9 that may be more than one, and to change return device—banknote dispenser 12.

### APPLICATION OF THE UTILITY MODEL

According to the description and the enclosed drawing, the computerized devices for sale of goods and/or services consists of the banknote validating device 1 and POS terminal 13 that are connected to computer 2 containing processor with x86 processor architecture or processor with RISC processor architecture, through USB, serial port or other known way of communication between such devices. When a banknote is inserted into the banknote validating device 1 or when a card is used at POS terminal 13, it is actuated in accordance with the installed software and checks the validity and the denomination of the banknote. After the end of the recognition process, the banknote is sent to storage box 3 and the banknote validating device sends data to the computer 2. In the same way, when a bank card is used at POS terminal 13, data is compiled and sent to the computer 2.

When it receives data from the validating device 1 or the POS terminal 13, the computer's processor checks in the memory the meaning of the data according to the installed software and performs the relevant step from the software algorithm to the appropriate device (memory 4, display 6), to printer 7 or to the executive device 9 which provides the service for which it was paid. The activity is stored in the memory 4 for further use for different purposes such as sending information to a remote server through communication device 8.

The computerized device for sale of goods and/or services operates as follows:

An embodiment of the device is placed in a place of easy access. A potential customer of the service provided (e.g. sale of vouchers for mobile telephone) inserts a banknote in the banknote validating device 1 or a card in the POS terminal 13 that are installed in a common housing with the computer 2 and its peripheral devices. The banknote validating device 1 recognizes the denomination of the banknote and verifies its validity, or the POS terminal 13 verifies that funds are available on the bank card, and sends the relevant data to the computer 2 which communicates with the memory 4, the console part (keyboard 5, display 6, printer 7, communication device 8 or executive device 9) and determines the following action. An example of such action is the printing of a number of a voucher for mobile telephone received by the computerized device through Internet or network connection to a dedicated server that may belong to the mobile service operator or to a company that has signed a contract with the mobile service operator for the sale of vouchers. The voucher is then printed on the printer 7 connected to the computer. Other examples of following action may be the lifting of the barrier at a public parking, granting access to, Internet connection, banknote exchange, currency exchange, and so on.

Yet another example of service providing may be the transfer of the amount indicated by the banknote inserted into the banknote validating device 1 to the bank account connected with the bank card inserted into the POS terminal 13.

### OTHER EXAMPLES

Sales of Vouchers for Mobile Telephones:

The computerized device for sale of goods and/or services comprises the banknote validating device 1 which is connected to the computer 2 through connection 11 and the POS terminal 13 coupled to the computer 2 through connection 14. The computer 2 includes a processor with x86 processor architecture or processor with RISC processor architecture, with installed appropriate software for control of the data, and it is connected to memory. The computer 2 is further coupled to a console part which, depending on the specific embodiment may comprise a display 6, a keyboard 5 and/or a printer 7, and it is connected to executive devices 9 that may be more than one, and to change return device (banknote dispenser) 12. The banknote inserted in the banknote validating device 1 is checked (validated) in terms of denomination and authenticity and then transported for storage in the box incorporated in the banknote validating device; or, the bank card inserted into the POS terminal 13 is checked for availability through the connection to a server and a transaction is commanded by to the bank server to the device operator's account using the software installed on the computer allows the purchase of a voucher for mobile telephone services up to the generated availability. The computer 2 connects through communication device 8 to an authorized server of the mobile service operator or of a third party and sends application for issuing a voucher number. The mobile service operator's server generates that voucher and sends it to the device through connection 15. The device prints the voucher on printer 7.

Funding a Bank Account Using the Device:

The amount of money inserted into the banknote validating device 1 is stored in the box of the banknote validating device and an application is sent to the computer to fund the balance of a bank account connected with the bank card inserted into the POS terminal 13. The computer 2 connects through the communication device 8 to an authorized bank server or a central server and sends an application to increase the availability of the account related to the bank card inserted into the POS terminal 13.

1. Computerized device for sale of goods and/or services comprising a banknote validating device, a computer system connected to a console part, executive device and communication device, characterized by the existence of digital wired or wireless connection (11) between the banknote validating device (1) and the computer (2), and of a digital wired or wireless connection (14) between the POS terminal (13) and the computer (2) wherein the computer comprises a processor with x86 processor architecture or processor with RISC processor architecture, memory (4) and peripheral devices like keyboard (5), display (6), printer (7) and at least one executive device (9), the computerized device being located in a separate housing.

2. The computerized device for sale of goods and/or services as claimed in claim 1 further characterized by the possibility, through wired or wireless connection (15), to communicate with a remote server (10) to verify the availability of funds on ban cards and the possibility to fund bank accounts related to these cards through the banknote validating device (1) and the computer (2) to the extent of the amount of money inserted into the banknote validating device (1) performed automatically and independently by the machine through wired or wireless computer network for exchange of information from and to the device.
